(19) United States
(12) Patent Application Publication
(10) Pub. No.: US 2026/0254763 A1
(43) Pub. Date: Aug. 27, 2026

(54) OPTIMIZED UPLINK TRANSMISSION WITH UE ASSISTED INFORMATION

(71) Applicant: Nokia Technologies Oy, Espoo (FI)

(72) Inventors: Zexian LI, Espoo (FI); Matti Einari LAITILA, Oulu (FI); Chunli WU, Beijing (CN); Devaki CHANDRAMOULI, Plano, TX (US); Gayathri TADAS, Karnataka (IN)

(21) Appl. No.: 19/100,764

(22) PCT Filed: Aug. 5, 2022
(86) PCT No.: PCT/CN2022/110622

§ 371 Date: Feb. 3, 2025

(51) Int. Cl. H04L 47/28

(52) U.S. Cl. CPC H04L 47/28

(57) ABSTRACT

Embodiments of the present disclosure relate to UL transmission with UE assisted information. A first device determines first preferred burst timing information for an application associated with the first device. The first device transmits a message to a second device serving the first device, the message including the first preferred burst timing information. The first device receives updated burst timing information for the application from a third device. The first device causes a generation pattern of a UL traffic flow to be adjusted by the application based on the updated burst timing information.

### FIELD

Various example embodiments relate to the field of telecommunication and in particular, to devices, methods, apparatuses and computer readable storage media for uplink (UL) transmission with user equipment (UE) assisted information.

### BACKGROUND

There are many applications that generate periodic traffic streams. In other words, the applications send a packet or a burst of packets periodically, for instance every two, five or ten millisecond (ms). The applications with periodic traffic may have extremely strict latency requirements for end-to-end network delays. For example, the delay of every burst needs to be constant, such as 2 ms. Examples of such applications may comprise applications used in industrial automation, or consumer applications such as audio, video, gaming, Extended Reality (XR) or tactile communications.

### SUMMARY

In general, example embodiments of the present disclosure provide a solution for UL transmission with UE assisted information.
In a first aspect, there is provided a first device. The first device comprises at least one processor and at least one memory storing instructions that, when executed by the at least one processor, cause the first device at least to: determine first preferred burst timing information for an application associated with the first device; transmit a message to a second device serving the first device, the message comprising the first preferred burst timing information; receive updated burst timing information for the application from a third device; and cause a generation pattern of a UL traffic flow to be adjusted by the application associated with the first device based on the updated burst timing information.
In a second aspect, there is provided a second device. The second device comprises at least one processor and at least one memory storing instructions that, when executed by the at least one processor, cause the second device at least to: receive a message from a first device served by the second device, the message comprising first preferred burst timing information for an application associated with the first device; and transmit, to a third device, the first preferred burst timing information.
In a third aspect, there is provided a third device. The third device comprises at least one processor and at least one memory storing instructions that, when executed by the at least one processor, cause the third device at least to: receive, from a second device, first preferred burst timing information for an application associated with a first device served by the second device; determine updated burst timing information for the application based on the first preferred burst timing information; and transmit the updated burst timing information to the first device.
In a fourth aspect, there is provided a method implemented at a first device. The method comprises: determining, at a first device, first preferred burst timing information for an application associated with the first device; transmitting a message to a second device serving the first device, the Message comprising the first preferred burst timing information; receiving updated burst timing information for the application from a third device; and causing a generation pattern of a UL traffic flow to be adjusted by the application based on the updated burst timing information.
In a fifth aspect, there is provided a method implemented at a second device. The method comprises: receiving, at a second device, a message from a first device served by the second device, the Message comprising first preferred burst timing information for an application associated with the first device; and transmitting, to a third device, the first preferred burst timing information.
In a sixth aspect, there is provided a method implemented at a third device. The method comprises: receiving, at a third device from a second device, first preferred burst timing information for an application associated with a first device served by the second device; determining updated burst timing information for the application based on the first preferred burst timing information; and transmitting the updated burst timing information to the first device.
In a seventh aspect, there is provided an apparatus. The apparatus comprises: means for determining, at a first device, first preferred burst timing information for an application associated with the first device; means for transmitting a message to a second device serving the first device, the Message comprising the first preferred burst timing information; means for receiving updated burst timing information for the application from a third device; and means for causing a generation pattern of a UL traffic flow to be adjusted by the application based on the updated burst timing information.
In an eighth aspect, there is provided an apparatus. The apparatus comprises: means for receiving, at a second device, a message from a first device served by the second device, the Message comprising first preferred burst timing information for an application associated with the first device; and means for transmitting, to a third device, the first preferred burst timing information.
In a ninth aspect, there is provided an apparatus. The apparatus comprises: means for receiving, at a third device from a second device, first preferred burst timing information for an application associated with a first device served by the second device; means for determining updated burst timing information for the application based on the first preferred burst timing information; and means for transmitting the updated burst timing information to the first device.
In a tenth aspect, there is provided a non-transitory computer readable medium comprising program instructions for causing an apparatus to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2 illustrates a flowchart illustrating a process for UL transmission according to some embodiments of the present disclosure;

FIGS. 3 to 5 illustrate an example of medium access control control element (MAC CE) according to some embodiments of the present disclosure, respectively;

FIG. 6 illustrates an example of a reduced buffering latency according to some embodiments of the present disclosure;

FIG. 7 illustrates a flowchart of a method implemented at a first device according to some embodiments of the present disclosure;

FIG. 8 illustrates a flowchart of a method implemented at a second device according to some other embodiments of the present disclosure;

FIG. 9 illustrates a flowchart of a method implemented at a third device according to still other embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, UE, a Subscriber Station (SS), a Portable Subscriber Station, a Mobile Station (MS), a sensor device or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the 3rd Generation Partnership Project (3GPP) Release 17, periodic delay-critical streams may be supported for Internet Protocol (IP) and Ethernet via generalized Time Sensitive Communication (TSC) mechanisms. In that case, an Application Function (AF) provides Quality of Service (QOS) requirements such as maximum delay for TSC QoS flows or traffic flows directly to the fifth generation system (5GS). In addition, for periodic traffic flows, the AF may provide the periodicity, and/or burst size. For periodic traffic flows, if the AF can determine burst arrival time (BAT), the AF may also provide the burst arrival time for a 5GS Ingress. Examples of the 5GS Ingress may comprise UE or user plane functions (UPF) depending on the flow direction. Thus, the sender transmission time is not provided by the network but is decided by the application itself.

The most critical part of the end-to-end network is the 5G radio access network (RAN). 5G RAN in many cases introduces a significant part of the end-to-end delay for the traffic streams and is also the bottleneck from the capacity perspective. Even if simple prioritization and overbooking may work in the other parts of the network, in RAN, dedicated resources (for example, uplink (UL) configured grant (CG) resource) have to be reserved for periodic delay-critical streams, especially considering the traffic with both latency and reliability requirements.

When Time Division Duplex (TDD) is used on a specific 5G New Radio (NR) radio band, the radio transmissions in UL and downlink (DL) alternate with a repeating cycle. While there is some flexibility to adjust the cycle time and durations of UL and DL transmission slots within it, at least some parts of the cycle are typically statically reserved for a specific direction. To avoid interference, this does not even happen at the granularity of a single cell or a single gNB but is common for a larger area. For example, currently in Japan, the regulated TDD operation pattern is with DL: UL ratio of 4:1 and operators are not allowed to change such ratio. In addition, one may claim the TDD operation pattern can be adjusted in some areas. However, considering there can be multiple UEs with similar requirement within one cell, it is not possible to the network to adjust the TDD operation pattern for all UEs simultaneously. Therefore, in practice, TDD cycles and the direction of the time slots cannot be adjusted based on individual traffic streams according to their burst arrival time, but rather the burst arrival time of the individual streams will need to be adjusted to the TDD cycles and the direction of the timeslots in order to achieve the optimal performance.

According to embodiments of the present disclosure, there is providing a solution for UL transmission with UE assisted information. According to the solution, a first device transmits a message to a second device serving the first device. The Layer-2 message comprises first preferred burst timing information for an application associated with the first device. In turn, the first device receives updated burst timing information for the application from a third device. The updated burst timing information is determined by the third device based on the first preferred burst timing information. Then, the first device causes a generation pattern of a traffic flow to be adjusted by the application based on the updated burst timing information. This solution may enable application associated with the first device to adapt the UL traffic flow generation behavior based on the first preferred burst timing information. In this way, the optimal end user experience may be achieved.

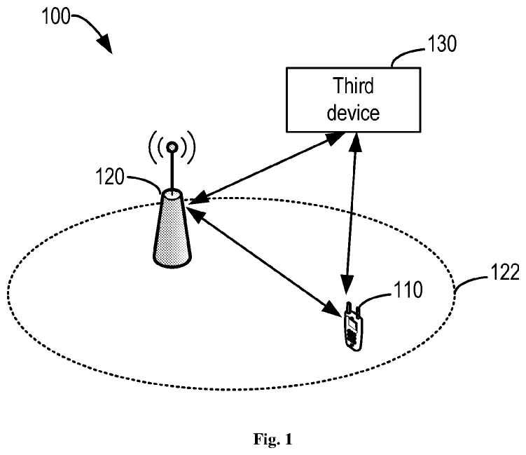

Principle and embodiments of the present disclosure will be described in detail below with reference to the accompanying drawings. Reference is first made to FIG. 1, which illustrates an example communication environment 100 in which embodiments of the present disclosure may be implemented. As shown in FIG. 1, the communication environment 100 comprises a first device 110, a second device 120 and a third device 130.

In this example, only for ease of discussion, the first device 110 is illustrated as a terminal device and the second device 120 is illustrated as an access network device serving the terminal device 110. For example, the first device 110 may be implemented as a UE. For example, the second device 120 may be implemented as a base station in an access network. Thus, the serving area of the second device 120 is called a cell 122. The cell 122 may be referred to as a serving cell of the first device 110.

It is to be understood that the terminal device and the base station are only example implementations of the first device 110 and the second device 120, respectively, without suggesting any limitation as to the scope of the present application. Any other suitable implementations are possible as well.

In some embodiments, the third device 130 may be implemented as a core network device. For example, the third device 130 may be implemented as an Application Function (AF) in a core network or a Session Management Function (SMF) in the core network.

It is to be understood that the number of the first, second and third devices and the number of cells as shown in FIG. 1 are only for the purpose of illustration without suggesting any limitations. The environment 100 may include any suitable number of first, second and third devices as well as cells adapted for implementing embodiments of the present disclosure.

The communications in the environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), and the sixth generation (6G) communication protocols.

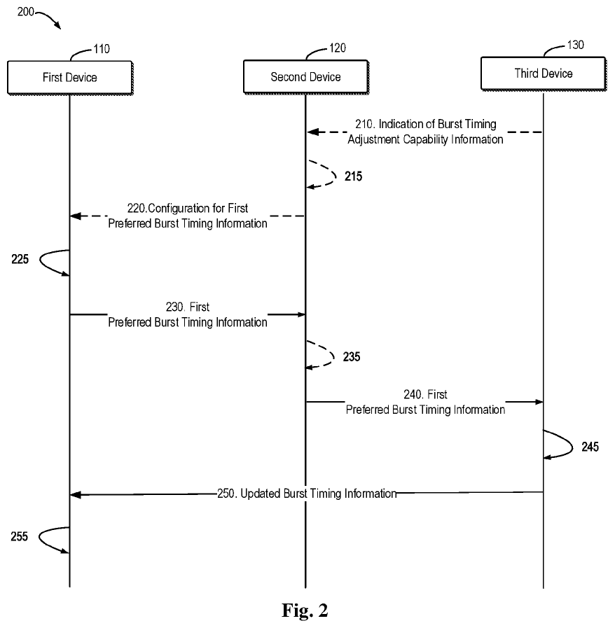

FIG. 2 illustrates a signaling chart illustrating a process 200 for UL transmission in accordance with some example embodiments of the present disclosure. For the purpose of discussion, the process 200 will be described with reference to FIG. 1. The process 200 may involve the first device 110, the second device 120 and the third device 130 in FIG. 1.

The first device 110 determines 225 first preferred burst timing information for an application associated with the first device.

In some embodiments, the application may run on the first device. In other embodiments, the application may run on an external device connected to the first device. Examples of the external device may include but is not limited to a video camera.

In some embodiments, the first preferred burst timing information comprises an indication of at least one of the following:
an identity of a data radio bearer (DRB) for the UL traffic flow,
an identity of Quality of Service (QOS) flow associated with the UL traffic flow,
an identity of packet data unit (PDU) set associated with the UL traffic flow,
preferred UL burst arrival time,
a preferred UL burst arrival time offset,
a preferred length of an UL burst arrival time window (BAW), or
a periodicity of the UL traffic flow.

In some embodiments, the ID of the DRB, the ID of QoS flow or the ID of the PDU set may indicate the target DRB, QoS flow or PDU set for which the UL timing adjustment to be applied.

In some embodiments, the preferred UL burst arrival time may be reported in pro-active reporting mode. The format of the preferred UL burst arrival time may be absolute time or relative time (for example, taking one known timing instance e.g., a specific system frame number (SFN)).

In some embodiments, based on observation of UL traffic of the first device 110 and the available time slots for UL traffic transmission, the first device 110 may determine the preferred UL burst arrival time offset with respect to the UL burst arrival time and report the offset towards the second device 120 in a reactive mode. This option assumes that the first device 110 and the second device 120 are aware of the UL burst arrival time for the UL traffic. Thus, the preferred UL burst arrival time offset may be determined with reference to the UL burst arrival time.

In embodiments where a proactive mode is used, a preferred UL burst arrival time window may be determined based on the preferred UL burst arrival time reported by the first device 110 and the preferred length of the UL burst arrival time window. Alternatively, in embodiments where a reactive mode is used, the preferred UL burst arrival time window may be determined based on the preferred UL burst arrival time offset, an original UL burst arrival time and the preferred length of the UL burst arrival time window. The preferred UL burst arrival time window may indicate expected earliest and latest arrival time. In addition, the preferred UL burst arrival time window may offer more flexibility for traffic generation at the application (e.g. instead of one time instant).

In some embodiments, the periodicity of the UL traffic flow (also referred to as preferred UL burst periodicity) may be used by the application to set or adjust traffic generation periodicity.

In some embodiments, the first device 110 may determine the first preferred burst timing information based on at least one of the following: a configuration for the first burst timing information, a radio resource allocation from the second device 120, or processing time for the UL traffic flow.

In some embodiments, the configuration for the first preferred burst timing information comprises at least one of the following:
burst timing adjustment capability information for the application,
UL burst arrival time,
at least one candidate length of a UL burst arrival time window,
at least one candidate periodicity of the UL traffic flow, or
a threshold or event for trigger of the determination of the first preferred burst timing information.

In some embodiments, the burst timing adjustment capability information comprises at least one of the following:
an indication whether an ID of a DRB, an ID of QoS flow or an ID of PDU set for the UL traffic flow is to be included in the first preferred burst timing information,
a pro-active mode for transmitting the Layer-2 message,
a reactive mode for transmitting the Layer-2 message, or
a timing granularity for a preferred UL burst arrival time offset.

In some embodiments, the indication whether the ID of the DRB (also referred to as DRB ID), the ID of QoS flow (also referred to as QoS ID) or an ID of PDU set (also referred to as PDU set ID) for the UL traffic flow is to be included in the first preferred burst timing information may be used to activate or deactivate reporting for each individual DRB, QoS flow or PDU set. For example, by default, no reporting is needed if no specific activation configuration is received. It shall be noted that in principle the activation or deactivation of such reporting may be done via lower layer signaling as well, such as MAC CE or even physical layer (PHY) signaling.

In some embodiments, the pro-active mode may be used, for example, during the phase of PDU session establishment or modification but before data traffic generation from the application.

In some embodiments, the reactive mode may be used after data traffic from the application arrivals at the first device 110.

In some embodiments, the timing granularity for a preferred UL burst arrival time offset may comprise one or multiple values for the preferred UL burst arrival time offset. The timing granularity may be used to define the timing granularity for the reported value. Common or different values could be configured for each DRB. Alternatively, it could also be predefined for example in the standard specification without configuration.

In some embodiments, the at least one candidate length of the UL burst arrival time window may be used to define the length of UL burst arrival time window. It is possible to configure multiple values and the first device 110 may indicate via the Layer-2 message which one is preferred. Alternatively, one or more codepoints for the report may be predefined for example in the standard specification without configuration.

In some embodiments, the at least one candidate periodicity of the UL traffic flow may be used to define the preferred periodicity. It is possible to configure multiple values and the first device 110 may indicates via the Layer-2 message which one is preferred.

In some embodiments, the threshold or event for trigger of the determination of the first preferred burst timing information may be used to trigger the determination of the first preferred burst timing information in case where the reactive mode is used. For example, once the buffering latency or the timing offset (between the actual traffic and the preferred burst arrival time) is greater than the configured threshold, the determination of the first preferred burst timing information is triggered.

In some embodiments, the first device 110 may receive 220 the configuration for the first preferred burst timing information from the second device 120. For example, the first device 110 may receive the configuration via a radio resource control (RRC) message. In this regard, the configuration may be referred to as RRC configuration.

In some embodiments, a first subset of parameters in the configuration for the first preferred burst timing information may be received from the second device 120. For example, the burst arrival time window may be determined by the second device 120 based on the preferred burst arrival time or preferred burst arrival time offset received from the first device 110.

In some embodiments, a second subset of parameters in the configuration for the first preferred burst timing information may be predefined. For example, the timing granularity for the preferred UL burst arrival time offset may be predefined. For another example, the at least one candidate length of the UL burst arrival time window may be predefined.

In embodiments where the configuration for the first preferred burst timing information comprise the burst timing adjustment capability information for the application, the second device 120 may receive 210, from the third device 130, an indication of the burst timing adjustment capability information. In turn, the second device 120 may determine 215 the burst timing adjustment capability information based on the indication.

With continued reference to FIG. 2, the first device 110 transmits 230 a message to the second device 120 serving the first device 110. The message comprises the first preferred burst timing information.

In some embodiments, the message comprises a Layer-2 message. The Layer-2 message may comprise a medium access control control element (MAC CE). The MAC CE comprises the first preferred burst timing information. Some embodiments of the MAC CE will be described later with reference to FIGS. 3 to 5.

Alternatively, in some embodiments, the Layer-2 message may comprise a Packet Data Convergence Protocol (PDCP) control packet data unit (PDU). The PDCP control PDU comprises the first preferred burst timing information.

Accordingly, the second device 120 receives the Layer-2 message comprising the first preferred burst timing information. In turn, the second device 120 transmits 240 the first preferred burst timing information to the third device 130.

Upon receiving the first preferred burst timing information, the third device 130 determines 245 updated burst timing information for the application based on the first preferred burst timing information. In turn, the third device 130 transmits 250 the updated burst timing information to the first device 110.

Upon receiving the updated burst timing information, the first device 110 causes a generation pattern of a UL traffic flow to be adjusted by the application based on the updated burst timing information. In this way, the optimal end user experience may be achieved.

In some embodiments, the second device 120 may determine 235 second preferred burst timing information for the application based on the first preferred burst timing information. For example, in embodiments where the first preferred burst timing information comprises the preferred UL burst arrival time offset but does not comprise the preferred UL burst arrival time, the second device 120 may determine the preferred UL burst arrival time based on the preferred UL burst arrival time offset. In turn, the second device 120 may include the preferred UL burst arrival time in the second preferred burst timing information. In turn, the second device 120 transmits the second preferred burst timing information to the third device 130.

In some embodiments, there is overlapping between the second preferred burst timing information and the first preferred burst timing information. In other words, the second preferred burst timing information may comprise the first preferred burst timing information and addition information. For example, in embodiments where the first preferred burst timing information comprises the preferred UL burst arrival time offset but does not comprise the preferred UL burst arrival time, the second preferred burst timing information may comprise the first preferred burst timing information and the preferred UL burst arrival time determined based on the first preferred burst timing information. In such embodiments, the third device 130 may determine the updated burst timing information based on the second preferred burst timing information.

In some embodiments, there is no overlapping between the second preferred burst timing information and the first preferred burst timing information. For example, in embodiments where the first preferred burst timing information comprises the preferred UL burst arrival time offset but does not comprise the preferred UL burst arrival time, the second preferred burst timing information may only comprise the preferred UL burst arrival time determined based on the first preferred burst timing information. In such embodiments, the third device 130 may determine the updated burst timing information based on the first preferred burst timing information and the second preferred burst timing information.

In some embodiments, the first device 110 may determine the first preferred burst timing information based on determining that at least one trigger condition is satisfied.

In some embodiments, the first device 110 may determine the at least one trigger condition is satisfied by determining at least one of the following:
a delay-critical guaranteed bit rate (GBR) bearer as requested by the second device 120,
a difference between observed burst arrival time of a data burst from the application associated with the first device 110 and a preferred burst arrival time of the data burst exceeding a first threshold, or
buffering latency for the data burst exceeding a second threshold.

As described above, the Layer-2 message may comprise an MAC CE. The MAC CE comprises the first preferred burst timing information. Some embodiments of the MAC CE will be described later with reference to FIGS. 3 to 5.

FIG. 3 illustrates an example of a burst arrival time offset MAC CE according to some embodiments of the present disclosure. In the example of FIG. 3, the first device 110 only reports the preferred UL burst arrival time offset to the second device 120 via the burst arrival time offset MAC CE of FIG. 3 when the triggering condition is fulfilled. This corresponds to the reactive mode where at least the first (i.e., the initial) data packet is already delivered to the first device 110.

In the burst arrival time offset MAC CE 300, DRB ID is used to indicate to which DRB and corresponding QoS flow(s) the reported burst arrival time offset should be applied. The “Burst arrival time offset” is used to carry the value for the second device 120 to determine the burst arrival time offset (based on, for example, the reported value and the configured timing granularity or possible codepoints) comparing to the original or current burst arrival time. Then, the second device 120 can forward this information to the third device 130 (e.g. SMF and further to AF). With this example, RRC configuration may include the DRB(s) which such reporting is activated, triggering condition and the timing granularity.

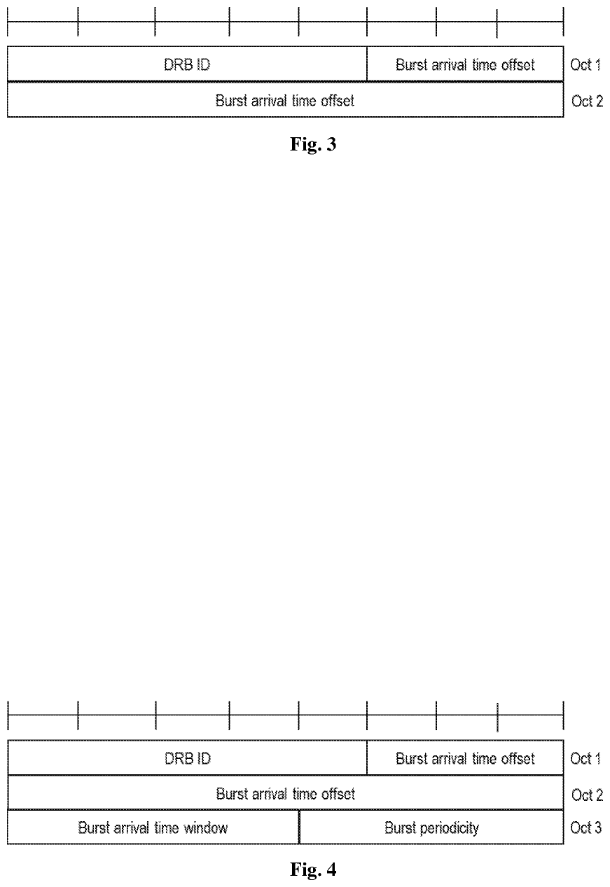

Depending on the scenario, other MAC CE implementation examples may include more elements. FIG. 4 illustrates another example of an MAC CE according to some embodiments of the present disclosure. In the example of FIG. 4, in addition to reporting the preferred burst arrival time offset, the first device 110 may also report the preferred burst arrival time window and preferred burst periodicity. In this example, for both preferred burst arrival time window and preferred burst periodicity, one from the configured values (in total 16 values can be configured with 4-bit length) can be reported.

In case where the proactive mode is used, instead of reporting the preferred burst arrival time offset, the preferred burst arrival time may be reported. For example, the timing information may take the starting point of the SFN frame as reference.

FIG. 5 illustrates a further example of an MAC CE according to some embodiments of the present disclosure. In the example of FIG. 5, the MAC CE could indicate report for multiple DRBs. In case the first device 110 reports information applicable for multiple DRBs, the first device 110 may include multiple DRB IDs in the MAC CE as shown in FIG. 5.

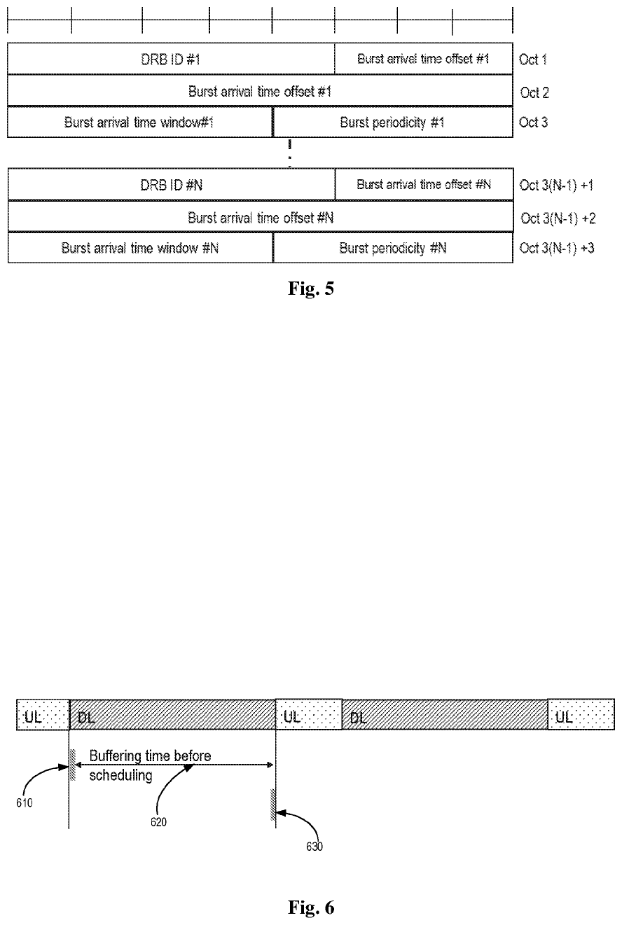

With the embodiments of the present disclosure, buffering latency may be reduced. FIG. 6 illustrates an example of buffering latency with and without the embodiments of the present disclosure. In the example of FIG. 6, the TDD DL: UL ratio is assumed to be 4:1. Slot based scheduling is used. That is, scheduling can be done only at the beginning of the DL slot, i.e., packets arriving after a starting point of DL slot will be scheduled in the next DL slot.

In case where the embodiments of the present disclosure are not used, packets arrives right before a starting point 610 of DL slot and the packets will be transmitted in the UL slot right after an end 630 of the DL slot. Thus, there is buffering latency 620 for the packets.

In case where the embodiments of the present disclosure are used, packets may arrive and be transmitted in the UL slot right after the end 630 of the DL slot. Thus, buffering latency may be reduced significantly.

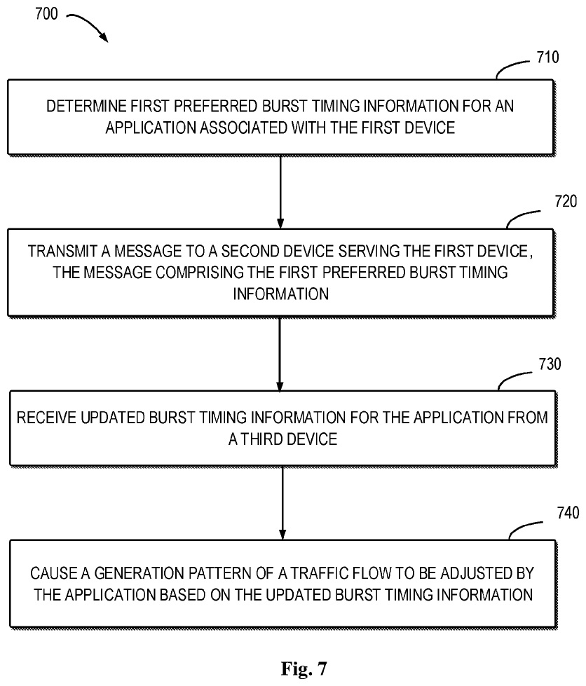

FIG. 7 shows a flowchart of an example method 700 implemented at a first device in accordance with some example embodiments of the present disclosure. For the purpose of discussion, the method 700 will be described from the perspective of the first device 110 with respect to FIG. 1.

At block 710, the first device 110 determines first preferred burst timing information for an application associated with the first device 110.

At block 720, the first device 110 transmits a message to a second device serving the first device, the message comprising the first preferred burst timing information.

At block 730, the first device 110 receives updated burst timing information for the application from a third device.

At block 740, the first device 110 causes a generation pattern of a UL traffic flow to be adjusted by the application based on the updated burst timing information.

In some embodiments, the message comprises a Layer-2 message, and the Layer-2 message comprises a medium access control control element (MAC CE), the MAC CE comprising the first preferred burst timing information.

In some embodiments, the message comprises a Layer-2 message, and the Layer-2 message comprises a Packet Data Convergence Protocol (PDCP) control packet data unit (PDU), the PDCP control PDU comprising the first preferred burst timing information.

In some embodiments, the first preferred burst timing information comprises an indication of at least one of the following: an identity of a data radio bearer (DRB) for the traffic flow, an identity of Quality of Service (QOS) flow associated with the traffic flow, an identity of packet data unit (PDU) set associated with the traffic flow, preferred uplink burst arrival time, a preferred uplink burst arrival time offset, a preferred length of an uplink burst arrival time window (BAW), or a periodicity of the traffic flow.

In some embodiments, determining the first preferred burst timing information comprises: determining the first preferred burst timing information based on at least one of the following: a configuration for the first preferred burst timing information, a radio resource allocation from the second device, or processing time for the traffic flow.

In some embodiments, the configuration for the first preferred burst timing information comprises at least one of the following: burst timing adjustment capability information for the application, burst arrival time, at least one candidate length of an uplink burst arrival time window (BAW), at least one candidate periodicity of the traffic flow, or a threshold or event for trigger of the determination of the first preferred burst timing information.

In some embodiments, the burst timing adjustment capability information comprises at least one of the following: an indication whether an identity of a data radio bearer (DRB), an identity of Quality of Service (QOS) flow or an identity of packet data unit (PDU) for the traffic flow is to be included in the first preferred burst timing information, a pro-active mode for transmitting the Layer-2 message, a reactive mode for transmitting the Layer-2 message, or a timing granularity for a preferred uplink burst arrival time offset.

In some embodiments, the method 700 further comprises: receiving a first subset of parameters in the configuration for the first preferred burst timing information from the second device.

In some embodiments, a second subset of parameters in the configuration for the first preferred burst timing information is predefined.

In some embodiments, determining the first preferred burst timing information comprises determining the first preferred burst timing information based on determining that at least one trigger condition is satisfied.

In some embodiments, determining that at least one trigger condition is satisfied comprises: determining the at least one trigger condition is satisfied by determining at least one of the following: a delay-critical guaranteed bit rate (GBR) bearer as requested by the second device, a difference between observed burst arrival time of a data burst from the application and a preferred burst arrival time of the data burst exceeding a first threshold, or buffering latency for the data burst exceeding a second threshold.

In some embodiments, the first device comprises a terminal device, the second device comprises an access network device, and the third device comprises a core network device.

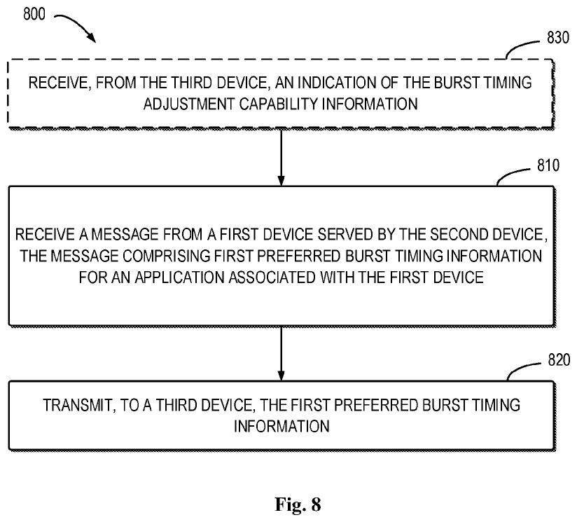

FIG. 8 shows a flowchart of an example method 800 implemented at a second device in accordance with some example embodiments of the present disclosure. For the purpose of discussion, the method 800 will be described from the perspective of the second device 120 with respect to FIG. 1.

At block 810, the second device 120 receives a message from a first device served by the second device, the message comprising first preferred burst timing information for an application associated with the first device.

At block 820, the second device 120 transmits, to a third device, the first preferred burst timing information.

In some embodiments, optionally, at block 830, the second device 120 may receive from the third device 130, an indication of the burst timing adjustment capability information. In turn, the second device 120 may determine the burst timing adjustment capability information based on the indication.

In some embodiments, the message comprises a Layer-2 message, and the Layer-2 message comprises a medium access control control element (MAC CE), the MAC CE comprising the first preferred burst timing information.

In some embodiments, the message comprises a Layer-2 message, and the Layer-2message comprises a Packet Data Convergence Protocol (PDCP) control packet data unit (PDU), the PDCP control PDU comprising the first preferred burst timing information.

In some embodiments, at least one of the first preferred burst timing information comprises an indication of at least one of the following: an identity of a data radio bearer (DRB) for the traffic flow, an identity of Quality of Service (QOS) flow associated with the traffic flow, an identity of packet data unit (PDU) set associated with the traffic flow, preferred uplink burst arrival time, a preferred uplink burst arrival time offset, a preferred length of an uplink burst arrival time window (BAW), or a periodicity of the traffic flow.

In some embodiments, the method 800 further comprises: transmitting, to the first device, a first subset of parameters in a configuration for the first preferred burst timing information.

In some embodiments, the configuration for the first preferred burst timing information comprises at least one of the following: burst timing adjustment capability information for the application, burst arrival time, at least one candidate length of an uplink burst arrival time window (BAW), at least one candidate periodicity of the traffic flow, or a threshold or event for trigger of the determination of the first preferred burst timing information.

In some embodiments, the burst timing adjustment capability information comprises at least one of the following: an indication whether an identity of a data radio bearer (DRB), an identity of Quality of Service (QOS) flow or an identity of packet data unit (PDU) for the traffic flow is to be included in the first preferred burst timing information, a pro-active mode for transmitting the Layer-2 message, a reactive mode for transmitting the Layer-2 message, or a timing granularity for a preferred uplink burst arrival time offset.

In some embodiments, the method 800 further comprises: determining second preferred burst timing information for the application based on the first preferred burst timing information; and transmitting the second preferred burst timing information to the third device.

In some embodiments, the first preferred burst timing information comprises the preferred uplink burst arrival time offset. In some embodiments, determining the second preferred burst timing information comprises: determining the preferred uplink burst arrival time to be comprised in the second preferred burst timing information based on the preferred uplink burst arrival time offset.

In some embodiments, the first device comprises a terminal device, the second device comprises an access network device, and the third device comprises a core network device.

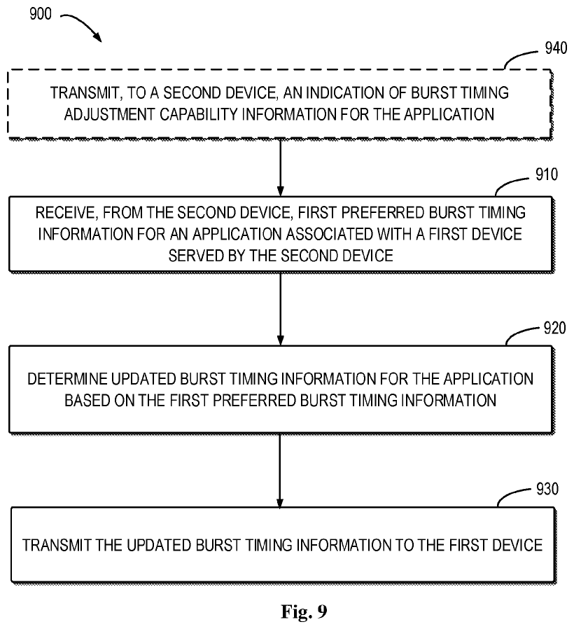

FIG. 9 shows a flowchart of an example method 900 implemented at a third device in accordance with some example embodiments of the present disclosure. For the purpose of discussion, the method 900 will be described from the perspective of the third device 130 with respect to FIG. 1.

At block 910, the third device 130 receives, from a second device, first preferred burst timing information for an application associated with a first device served by the second device.

At block 920, the third device 130 determines updated burst timing information for the application based on the first preferred burst timing information.

At block 930, the third device 130 transmits the updated burst timing information to the first device.

In some embodiments, optionally, at block 940, the third device 130 may transmit, to the second device 120, an indication of the burst timing adjustment capability information.

In some embodiments, the first preferred burst timing information comprises an indication of at least one of the following: an identity of a data radio bearer (DRB) for the traffic flow, an identity of Quality of Service (QOS) flow associated with the traffic flow, an identity of packet data unit (PDU) set associated with the traffic flow, preferred uplink burst arrival time, a preferred uplink burst arrival time offset, a preferred length of an uplink burst arrival time window (BAW), or a periodicity of the traffic flow.

In some embodiments, the first device comprises a terminal device, the third device comprises an access network device, and the third device comprises a core network device.

In some example embodiments, an apparatus in a radio access network capable of performing any of the method 700 (for example, the first device 110) may comprise means for performing the respective operations of the method 700. The means may be implemented in any suitable form. For example, the means may be implemented in a circuitry or software module. The first apparatus may be implemented as or included in the first device 110. In some example embodiments, the means may comprise a processor and a memory.

In some example embodiments, the apparatus comprises: means for determining, at a first device, first preferred burst timing information for an application associated with the first device; means for transmitting a message to a second device serving the first device, the message comprising the first preferred burst timing information; means for receiving updated burst timing information for the application from a third device; and means for causing a generation pattern of a UL traffic flow to be adjusted by the application based on the updated burst timing information.

In some embodiments, the message comprises a Layer-2 message, and the Layer-2 message comprises a medium access control control element (MAC CE), the MAC CE comprising the first preferred burst timing information.

In some embodiments, the message comprises a Layer-2 message, and the Layer-2 message comprises a Packet Data Convergence Protocol (PDCP) control packet data unit (PDU), the PDCP control PDU comprising the first preferred burst timing information.

In some embodiments, the first preferred burst timing information comprises an indication of at least one of the following: an identity of a data radio bearer (DRB) for the traffic flow, an identity of Quality of Service (QOS) flow associated with the traffic flow, an identity of packet data unit (PDU) set associated with the traffic flow, preferred uplink burst arrival time, a preferred uplink burst arrival time offset, a preferred length of an uplink burst arrival time window (BAW), or a periodicity of the traffic flow.

In some embodiments, the means for determining the first preferred burst timing information comprises: means for determining the first preferred burst timing information based on at least one of the following: a configuration for the first preferred burst timing information, a radio resource allocation from the second device, or processing time for the traffic flow.

In some embodiments, the configuration for the first preferred burst timing information comprises at least one of the following: burst timing adjustment capability information for the application, burst arrival time, at least one candidate length of an uplink burst arrival time window (BAW), at least one candidate periodicity of the traffic flow, or a threshold or event for trigger of the determination of the first preferred burst timing information.

In some embodiments, the burst timing adjustment capability information comprises at least one of the following: an indication whether an identity of a data radio bearer (DRB), an identity of Quality of Service (QOS) flow or an identity of packet data unit (PDU) for the traffic flow is to be included in the first preferred burst timing information, a pro-active mode for transmitting the Layer-2 message, a reactive mode for transmitting the Layer-2 message, or a timing granularity for a preferred uplink burst arrival time offset.

In some embodiments, the apparatus further comprises: means for receiving a first subset of parameters in the configuration for the first preferred burst timing information from the second device.

In some embodiments, a second subset of parameters in the configuration for the first preferred burst timing information is predefined.

In some embodiments, the means for determining the first preferred burst timing information comprises means for determining the first preferred burst timing information based on determining that at least one trigger condition is satisfied.

In some embodiments, the means for determining that at least one trigger condition is satisfied comprises: means for determining the at least one trigger condition is satisfied by determining at least one of the following: a delay-critical guaranteed bit rate (GBR) bearer as requested by the second device, a difference between observed burst arrival time of a data burst from the application and a preferred burst arrival time of the data burst exceeding a first threshold, or buffering latency for the data burst exceeding a second threshold.

In some embodiments, the first device comprises a terminal device, the second device comprises an access network device, and the third device comprises a core network device.

In some example embodiments, an apparatus in a radio access network capable of performing any of the method 800 (for example, the second device 120) may comprise means for performing the respective operations of the method 800. The means may be implemented in any suitable form. For example, the means may be implemented in a circuitry or software module. The first apparatus may be implemented as or included in the second device 120. In some example embodiments, the means may comprise a processor and a memory.

In some example embodiments, the apparatus comprises: means for receiving, at a second device, a message from a first device served by the second device, the message comprising first preferred burst timing information for an application associated with the first device; and means for transmitting, to a third device, the first preferred burst timing information.

In some embodiments, the apparatus further comprises: means for receiving, from the third device, an indication of the burst timing adjustment capability information; and means for determining the burst timing adjustment capability information based on the indication.

In some embodiments, the message comprises a Layer-2 message, and the Layer-2 message comprises a medium access control control element (MAC CE), the MAC CE comprising the first preferred burst timing information.

In some embodiments, the message comprises a Layer-2 message, and the Layer-2 message comprises a Packet Data Convergence Protocol (PDCP) control packet data unit (PDU), the PDCP control PDU comprising the first preferred burst timing information.

In some embodiments, at least one of the first preferred burst timing information comprises an indication of at least one of the following: an identity of a data radio bearer (DRB) for the traffic flow, an identity of Quality of Service (QOS) flow associated with the traffic flow, an identity of packet data unit (PDU) set associated with the traffic flow, preferred uplink burst arrival time, a preferred uplink burst arrival time offset, a preferred length of an uplink burst arrival time window (BAW), or a periodicity of the traffic flow.

In some embodiments, the apparatus further comprises: means for transmitting, to the first device, a first subset of parameters in a configuration for the first preferred burst timing information.

In some embodiments, the configuration for the first preferred burst timing information comprises at least one of the following: burst timing adjustment capability information for the application, burst arrival time, at least one candidate length of an uplink burst arrival time window (BAW), at least one candidate periodicity of the traffic flow, or a threshold or event for trigger of the determination of the first preferred burst timing information.

In some embodiments, the burst timing adjustment capability information comprises at least one of the following: an indication whether an identity of a data radio bearer (DRB), an identity of Quality of Service (QOS) flow or an identity of packet data unit (PDU) for the traffic flow is to be included in the first preferred burst timing information, a pro-active mode for transmitting the Layer-2 message, a reactive mode for transmitting the Layer-2 message, or a timing granularity for a preferred uplink burst arrival time offset.

In some embodiments, the apparatus further comprises: means for determining second preferred burst timing information for the application based on the first preferred burst timing information; and means for transmitting the second preferred burst timing information to the third device.

In some embodiments, the first preferred burst timing information comprises the preferred uplink burst arrival time offset. In some embodiments, determining the second preferred burst timing information comprises: determining the preferred uplink burst arrival time to be comprised in the second preferred burst timing information based on the preferred uplink burst arrival time offset.

In some embodiments, the first device comprises a terminal device, the second device comprises an access network device, and the third device comprises a core network device.

In some example embodiments, an apparatus in a radio access network capable of performing any of the method 900 (for example, the third device 130) may comprise means for performing the respective operations of the method 900. The means may be implemented in any suitable form. For example, the means may be implemented in a circuitry or software module. The first apparatus may be implemented as or included in the third device 130. In some example embodiments, the means may comprise a processor and a memory.

In some example embodiments, the apparatus comprises: means for receiving, at a third device from a second device, first preferred burst timing information for an application associated with a first device served by the second device; means for determining updated burst timing information for the application based on the first preferred burst timing information; and means for transmitting the updated burst timing information to the first device.

In some embodiments, the apparatus further comprises: means for transmitting, to the second device, an indication of the burst timing adjustment capability information.

In some embodiments, the first preferred burst timing information comprises an indication of at least one of the following: an identity of a data radio bearer (DRB) for the traffic flow, an identity of Quality of Service (QOS) flow associated with the traffic flow, an identity of packet data unit (PDU) set associated with the traffic flow, preferred uplink burst arrival time, a preferred uplink burst arrival time offset, a preferred length of an uplink burst arrival time window (BAW), or a periodicity of the traffic flow.

In some embodiments, the first device comprises a terminal device, the third device comprises an access network device, and the third device comprises a core network device.

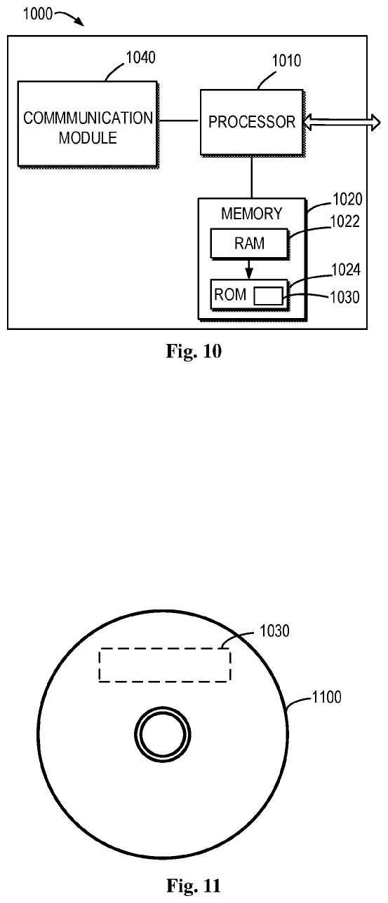

FIG. 10 is a simplified block diagram of a device 1000 that is suitable for implementing embodiments of the present disclosure. The device 1000 may be provided to implement the communication device, for example the first device 110, the second device 120 or the third device 130 as shown in FIG. 1. As shown, the device 1000 includes one or more processors 1010, one or more memories 1040 coupled to the processor 1010, and one or more transmitters and/or receivers (TX/RX) 1040 coupled to the processor 1010.

The TX/RX 1040 is for bidirectional communications. The TX/RX 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1020. The processor 1010 may perform any suitable actions and processing by loading the program 1030 into the RAM 1020.

The embodiments of the present disclosure may be implemented by means of the program 1030 so that the device 1000 may perform any process of the disclosure as discussed with reference to FIGS. 7 to 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 700, 800 and 900 as described above with reference to FIGS. 7-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context o/f the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A first device, comprising:
at least one processor; and
at least one memory storing instructions that, when executed by the at least one processor, cause the first device at least to:
determine first preferred burst timing information for an application associated with the first device;
transmit a message to a second device serving the first device, the message comprising the first preferred burst timing information;
receive updated burst timing information for the application from a third device; and
cause a generation pattern of a traffic flow to be adjusted by the application based on the updated burst timing information.

36. The first device of claim 35, wherein one of:
the message comprises a Layer-2 message, and the Layer-2 message comprises a medium access control control element (MAC CE), the MAC CE comprising the first preferred burst timing information; or
the message comprises a Layer-2 message, and the Layer-2 message comprises a Packet Data Convergence Protocol (PDCP) control packet data unit (PDU), the PDCP control PDU comprising the first preferred burst timing information.

37. The first device of claim 35, wherein the first preferred burst timing information comprises an indication of at least one of the following:
an identity of a data radio bearer (DRB) for the traffic flow,
an identity of Quality of Service (QOS) flow associated with the traffic flow,
an identity of packet data unit (PDU) set associated with the traffic flow,
preferred uplink burst arrival time,
a preferred uplink burst arrival time offset,
a preferred length of an uplink burst arrival time window (BAW), or
a periodicity of the traffic flow.

38. The first device of claim 35, wherein the first device is caused to determine the first preferred burst timing information based on at least one of the following:
a configuration for the first preferred burst timing information,
a radio resource allocation from the second device, or
processing time for the traffic flow.

39. The first device of claim 38, wherein the configuration for the first preferred burst timing information comprises at least one of the following:
burst timing adjustment capability information for the application,
burst arrival time,
at least one candidate length of an uplink burst arrival time window (BAW),
at least one candidate periodicity of the traffic flow, or
a threshold or event for trigger of the determination of the first preferred burst timing information.

40. The first device of claim 39, wherein the burst timing adjustment capability information comprises at least one of the following:
an indication whether an identity of a data radio bearer (DRB), an identity of Quality of Service (QOS) flow or an identity of packet data unit (PDU) for the traffic flow is to be included in the first preferred burst timing information,
a pro-active mode for transmitting the Layer-2 message,
a reactive mode for transmitting the Layer-2 message, or
a timing granularity for a preferred uplink burst arrival time offset.

41. The first device of claim 38, wherein one of:
the first device is further caused to receive a first subset of parameters in the configuration for the first preferred burst timing information from the second device; or
a second subset of parameters in the configuration for the first preferred burst timing information is predefined.

42. The first device of claim 35, wherein the first device is caused to determine the first preferred burst timing information based on determining that at least one trigger condition is satisfied.

43. The first device of claim 41, wherein the first device is caused to determine the at least one trigger condition is satisfied by determining at least one of the following:
a delay-critical guaranteed bit rate (GBR) bearer as requested by the second device,
a difference between observed burst arrival time of a data burst from the application and a preferred burst arrival time of the data burst exceeding a first threshold, or
buffering latency for the data burst exceeding a second threshold.

44. The first device of claim 35, wherein the first device comprises a terminal device, the second device comprises an access network device, and the third device comprises a core network device.

45. A method, comprising:
determining, at a first device, first preferred burst timing information for an application associated with the first device;
transmitting a message to a second device serving the first device, the message comprising the first preferred burst timing information;
receiving updated burst timing information for the application from a third device; and
causing a generation pattern of a traffic flow to be adjusted by the application based on the updated burst timing information.

46. An apparatus, comprising:
means for determining, at a first device, first preferred burst timing information for an application associated with the first device;
means for transmitting a message to a second device serving the first device, the message comprising the first preferred burst timing information;
means for receiving updated burst timing information for the application from a third device; and
means for causing a generation pattern of a traffic flow to be adjusted by the application based on the updated burst timing information.

47. The first device of claim 46, wherein one of:
the message comprises a Layer-2 message, and the Layer-2 message comprises a medium access control control element (MAC CE), the MAC CE comprising the first preferred burst timing information; or
the message comprises a Layer-2 message, and the Layer-2 message comprises a Packet Data Convergence Protocol (PDCP) control packet data unit (PDU), the PDCP control PDU comprising the first preferred burst timing information.

48. The first device of claim 46, wherein the first preferred burst timing information comprises an indication of at least one of the following:
an identity of a data radio bearer (DRB) for the traffic flow,
an identity of Quality of Service (QOS) flow associated with the traffic flow,
an identity of packet data unit (PDU) set associated with the traffic flow,
preferred uplink burst arrival time,
a preferred uplink burst arrival time offset,
a preferred length of an uplink burst arrival time window (BAW), or
a periodicity of the traffic flow.

49. The first device of claim 46, wherein the first device is caused to determine the first preferred burst timing information based on at least one of the following:
a configuration for the first preferred burst timing information,
a radio resource allocation from the second device, or
processing time for the traffic flow.

50. The first device of claim 49, wherein the configuration for the first preferred burst timing information comprises at least one of the following:
burst timing adjustment capability information for the application,
burst arrival time,
at least one candidate length of an uplink burst arrival time window (BAW),
at least one candidate periodicity of the traffic flow, or
a threshold or event for trigger of the determination of the first preferred burst timing information.

51. The first device of claim 50, wherein the burst timing adjustment capability information comprises at least one of the following:
an indication whether an identity of a data radio bearer (DRB), an identity of Quality of Service (QOS) flow or an identity of packet data unit (PDU) for the traffic flow is to be included in the first preferred burst timing information,
a pro-active mode for transmitting the Layer-2 message,
a reactive mode for transmitting the Layer-2 message, or
a timing granularity for a preferred uplink burst arrival time offset.

52. The first device of claim 46, wherein one of:
the first device is further caused to receive a first subset of parameters in the configuration for the first preferred burst timing information from the second device; or
a second subset of parameters in the configuration for the first preferred burst timing information is predefined.

53. The first device of claim 46, wherein the first device is caused to determine the first preferred burst timing information based on determining that at least one trigger condition is satisfied.

54. The first device of claim 53, wherein the first device is caused to determine the at least one trigger condition is satisfied by determining at least one of the following:
a delay-critical guaranteed bit rate (GBR) bearer as requested by the second device,
a difference between observed burst arrival time of a data burst from the application and a preferred burst arrival time of the data burst exceeding a first threshold, or
buffering latency for the data burst exceeding a second threshold.
